(19) United States
(12) Patent Application Publication
(10) Pub. No.: US 2011/0007159 A1
(43) Pub. Date: Jan. 13, 2011

(54) VIDEO SURVEILLANCE SYSTEM AND ASSOCIATED METHODS

(76) Inventors: David M. Camp, Carmi, IL (US); Samuel P. Westgate, Enfield, IL (US)

Correspondence Address: Robert L. Lundstrom, P.O. Box 160, Kaysville, UT, 84037, US

(21) Appl. No.: 12/794,737

(22) Filed: Jun. 5, 2010

Related U.S. Application Data
(60) Provisional application No. 61/184,792, filed on Jun. 6, 2009.

(51) Int. Cl. H04N 7/18

(52) U.S. Cl. 348/143; 348/E07.085

(57) ABSTRACT

A video surveillance system includes a video camera and a video data management device in communication with the video camera. The video data management device has a server providing a programmable interface for camera control and video management, a router in communication with the server to provide broadband internet access to the server, and a data storage device.

### PRIORITY CLAIM

This patent application claims benefit of U.S. Provisional Patent Application No. 61/184,792, filed on Jun. 6, 2009, which is herein incorporated by reference in its entirety for all purposes.

### BACKGROUND OF THE INVENTION

1. Field of the Invention

The present invention relates generally to video surveillance systems and more particularly to internet enabled video surveillance systems.

2. Related Art

Video surveillance equipment is evolving from analog cameras to internet enabled cameras (IP cameras) that can be connected to the internet via internet communication protocols. IP cameras allow transmission and in some cases storage of video information in compressed video data formats. Such cameras may also be coupleable to network architecture to reduce the amount of cables used in the video surveillance monitoring system.

Some Internet Protocol Video Server products (IPVS's) are available that allow conversion of analog camera signals to internet protocol transmittable video data on networked systems. Such IPVS's use wired network connections to retrieve and manage video data from the video surveillance system.

Unfortunately, networking such video surveillance systems with currently available networking components is problematic. For example, such a network would typically include an IP camera and a computer with networking components. Such systems are bulky and power intensive making them difficult to use in remote, mobile, wireless, or solar powered applications.

### SUMMARY OF THE INVENTION

The inventors of the present invention have recognized that it would be advantageous to develop a portable, self-contained, multi-function, remote video surveillance system with a configurable network server and communications platform that allows use in mobile, remote, low-powered, and even solar powered applications. Additionally, the inventors of the present invention have also recognized that it would be advantageous to develop a video surveillance system with a configurable network server and communications platform that provides for access to the live video stream signal, recorded video files, and control interfaces through a variety of connectivity options. Moreover, the inventors have recognized that it would be advantageous to develop a portable, self-contained, multi-function, remote video camera and recorder with a configurable network server and communications platform with minimal power requirements of less than about 650 ma.

The invention provides a video surveillance system including a video camera and a video data management device in communication with the video camera. The video data management device has a server providing a programmable interface for camera control and video management, and a router in communication with the server to provide broadband internet access to the server.

In accordance with a more detailed aspect of the present invention, the system includes a communications hub for receiving and delivering video data from the video camera, and a data storage device in communication with the video camera for recording and storing video data from the video camera.

The present invention also provides for methods for accessing a video surveillance camera with a remotely located computer using wireless, LAN and internet connections.

The present invention also provides for a method for alerting a remotely located user that a video surveillance camera has been activated.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a schematic view of a video surveillance system in accordance with an embodiment of the present invention;

FIG. 2 is front view of a video data management device of the video surveillance system of FIG. 1;

FIG. 3 is back view of the video data management device of FIG. 2; FIG. 4 is a schematic view of the video surveillance system of FIG. 1, shown configured for a LAN network connection;

FIG. 5 is a schematic view of the video surveillance system of FIG. 1, shown configured for a wireless network connection.

FIG. 6 is a flow chart of a method for remotely accessing a video surveillance camera through an internet connection.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein provide generally for a video surveillance system including at least one video camera and a video data management device. The video data management device is an integrated, self-contained unit including an internet protocol video server, a mobile broadband router with a wireless access point, an Ethernet switch, and a power regulator. The IP video server acquires video from video stream inputs and encodes and compresses the video streams into a format useful for transmission or storage of the video stream. The server also allows for real-time remote look-in of video feed as well as alarm triggered notification and recording to a secure digital card media. The router provides internet connectivity for the server and the Ethernet switch provides local networking capability for the server and the router. Together the server, router, Ethernet switch, and data storage device form an integrated device with a power consumption of less than approximately 700 milliamps. Power for the surveillance system can be provided by a 12 volt dc power source such as found in a motor vehicle, portable generator, or solar photovoltaic power cell.

In use a video camera or multiple video cameras can be set up and connected to the video data management device and powered on. Video feed streams from the video cameras are acquired by the server and encoded for storage or transmission. A user can access the video data from a computer connected to the server either through the router or through a LAN connected to the Ethernet switch. The video stream can be viewed as a live feed or can be recalled from the storage device. Advantageously, the router allows the video to be viewed from any internet enabled computer.

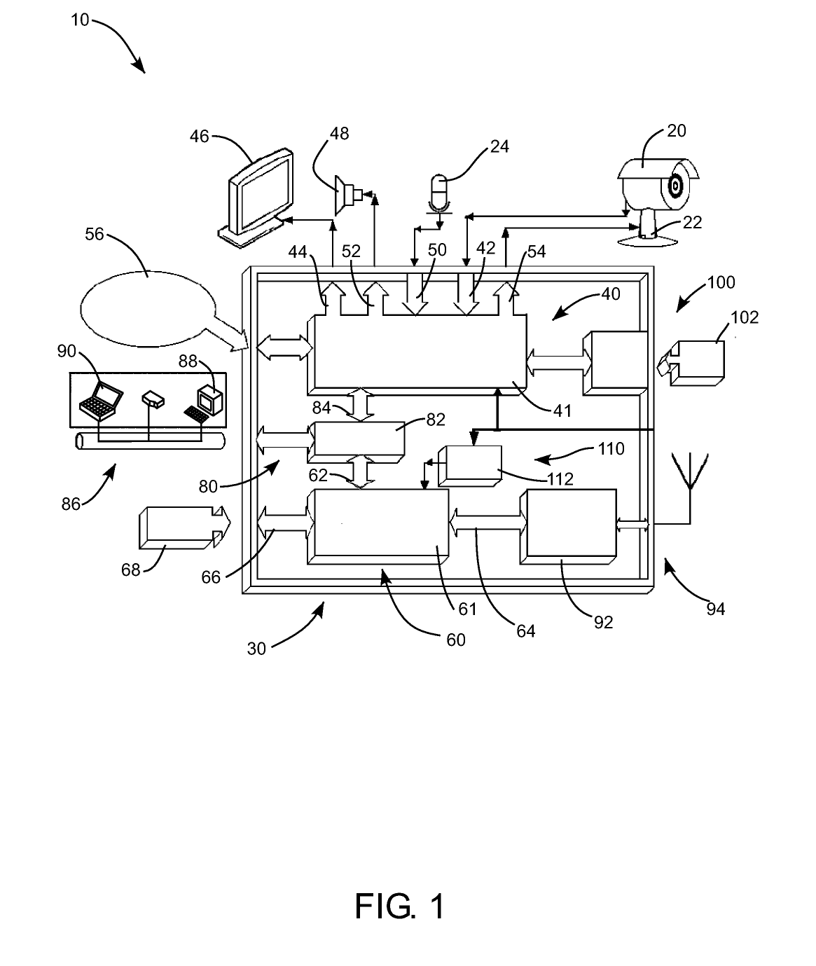

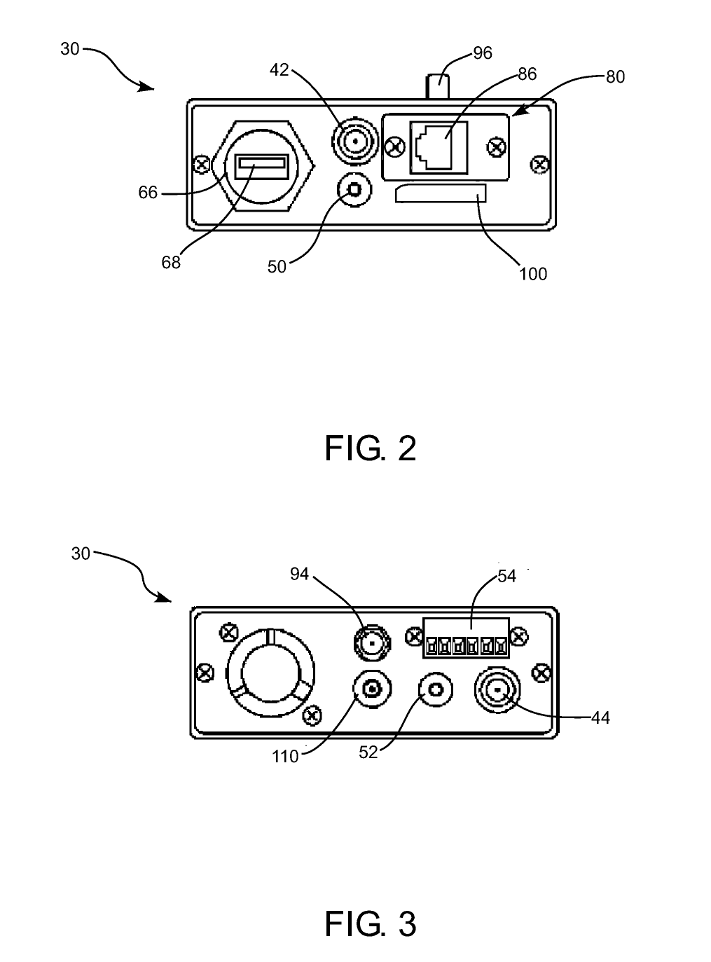

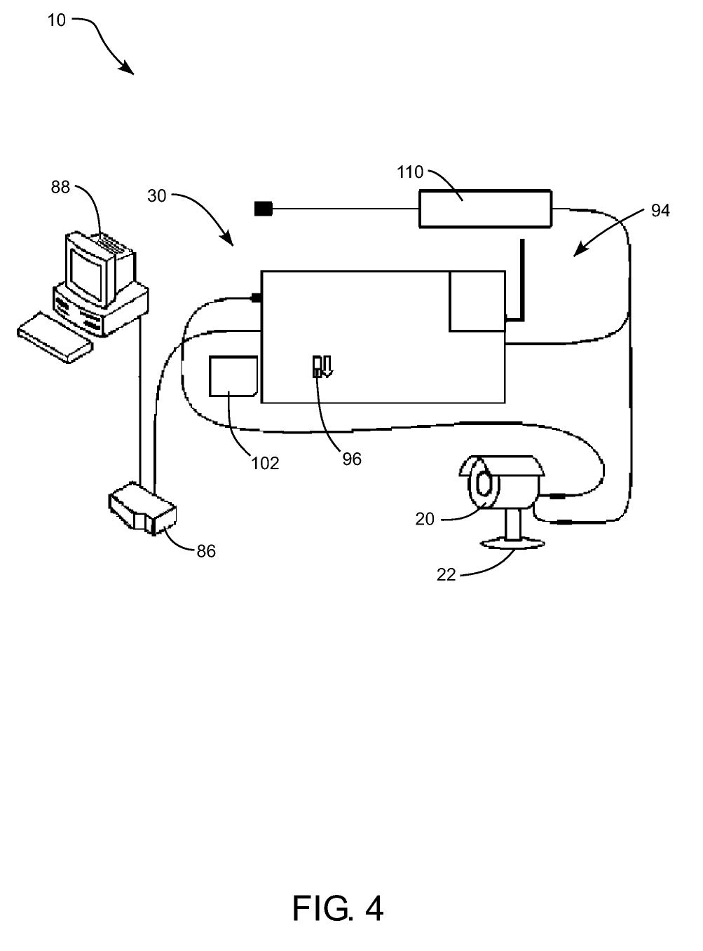

As illustrated in FIGS. 1-5, a video surveillance system, indicated generally at 10, is shown in accordance with an embodiment of the present invention for use in acquiring, storing, and transmitting video data. The surveillance system can include a video camera 20, and a video data management device, indicated generally at 30. The video data management device can be in communication with the camera to receive video data from the camera.

The video camera 20 can be a digital or analog camera with color or black and white image production capability. In one aspect, the camera can be an analog 380 CCTV line color camera with infrared emitters and a 3.6 mm lens that can capture up to 60 frames per second. The camera can function in low or zero light conditions using 12 integral infrared LED's. The camera can be positioned and secured with a mounting bracket 22. The mounting bracket can facilitate automatic tilt, zoom, and pan features of the camera.

It will be appreciated that while one camera 20 is shown in communication with the video surveillance system in FIGS. 1 and 4-5, other configurations can include multiple video cameras. Hence, the video data management device can be configured to process data from one camera or from a plurality of cameras. The video camera is one means for capturing audio-visual images.

The video data management device 30 can include an internet protocol video server, indicated generally at 40, a mobile broadband router, indicated generally at 60, a communication hub, indicated generally at 80, and a data storage device, indicated generally at 100.

The internet protocol video server (IPVS) 40 can be a wireless server using 802.11b, 802.11g or similar wireless protocols. The server can acquire and encode at least one audio-visual data stream into an optimal format for storage and transmission of the video data.

Referring to FIGS. 1-3, the server 40 can include a video signal input jack 42 and video output jack 44. The server can receive video signals, such as digital video or analog video signals from the camera 20, through the video input jack. The server can transmit video signal through the output jack 44 to an external viewing station 46 such as a television or computer monitor.

Similarly, the server 40 can include an audio signal input jack 50 and audio output jack 52. The server can receive audio signal through the audio input jack from an external microphone 24 or a microphone integrated with the camera 20. The server can transmit audio signal through the audio output jack to an external speaker 48 such as a speaker integrated with the external viewing station 46 or a speaker associated with the camera 20 to allow two way audio communications.

Additionally, the server 40 can include a serial port 54. The camera 20 can be in communication with the server via the serial cable port to allow the server to control the adjustable features of the camera such as the tilt, zoom, pan, low light, and the like.

The server 40 can include a microprocessor 41 that can be programmed to acquire, encode and compress the video data stream from the video camera 20. The server can encode the video data stream into a format that facilitates storage and transmission of the data. For example, the server can encode the video data into formats such as MJPEG, MPEG, MPEG-2, MPEG4, AVI, H.263, H.264, H.265, 3GPP, 3GPP2, .60d CCTV, .AJP CCTV, ASF, ASX, AVC Blueray, FLV, GVI, iMOVIE, ISF, M4V, MOV, VOB, DVD, WMV, VC-1, x264, and the like. It will be appreciated that other video formats, as known in the art, can also be encoded and compressed by the microprocessor. The server is one means for acquiring, compressing, and otherwise processing audio-visual data received from the video camera.

The server 40 can be programmed for static IP configuration or to receive IP configuration from an available DHCP host such as the router 60. An authentication secured web-based interface is provided in the server to allow for easy programming of the features and capabilities of the server. Moreover, the web-based interface allows the user to program video data management features of the server including video frame rate, resolution, image quality, and the like. The server also features a scheduling interface that allows the user to program the times and days that video is recorded to the storage device 100.

The server 40 can also include an FTP upload interface to upload image files to a user defined FTP site, and a programmable GPIO interface 56 with high or low level threshold inputs and high or low level output drives for interfacing with optional external monitoring devices. This includes but is not limited to panic buttons, and alarm indicator displays.

The microprocessor 41 of the server 40 can also include programmable alarm event triggers. The triggers can activate an alarm indicator if a predetermined event occurs. In one aspect, the alarm indicator can be a mobile message such as a text or email message that can be delivered by the server to a user if a programmed alarm event occurs. Alarm events can be monitored and detected by a motion detection circuit embedded in the server with an external interface programmable through a GPIO interface. For example, the motion detection circuit can provide motion detection with 96 independent blocks with 5 preset and 1000 programmable levels of sensitivity plus mask capability. When a motion detector is triggered, the server can activate the camera and notify the user of the activity. When connected to a live Internet connection the server can send captured frames of video data to the user along with the notification.

The server 40 can deliver the alarm notifications by way of an email message, SMS text, FTP, an instant message, a microblog message, a text message, a telephonic voice message, and the like. The alarm notification can include text, audio, pictorial and video clip data from the video camera. For example, the server can be programmed to send an email via the user's email Simple Mail Transfer Program (SMTP) account. In this case, the user's SMTP server address, account name and password information can be programmed into the IPVS 40 which can then use the SMTP account information to send an email notification to the user if an event trips an alarm trigger.

As seen in FIGS. 1 and 4-5, the server 40 can also be accessed via remote computer 88 or 90 operating a multi-camera monitoring software program so that the video surveillance system 10 can function with a single camera 20 as shown, or with multiple cameras as desired. Additionally, the server can be remotely accessible by an internet enabled computer to provide remote monitoring and programming of the video cameras.

Returning to FIG. 1, the mobile broadband router 60 can include a microprocessor 61 and programming for providing access to the server 40 from a variety of clients. The microprocessor can include programming to provide access to stored video data and live video feed from the video camera 20. In one aspect, the mobile broadband router can include an activated compatible USB Modem 68. In another aspect, the mobile broadband router can include a tethered cellular phone with a data plan that can be inserted into a USB port 66 on the video data management device 30. In yet another aspect, the mobile broadband router can include a cellular based wireless modem (not shown) that can be inserted into the USB port on the video data management device. Other mobile broadband router devices as known in the art may also be used provided the enable the video data management device as a WiFi hotspot. The mobile broad band router described herein is one means for routing the video images to a remote computer.

The router 60 can be in communication with the communications hub 80 via a LAN interface 62. Additionally, the router can include a wireless access point (WAP) interface 64 and a USB broadband modem interface 66 to provide connectivity to the server 40. The WAP interface 64 can use 802.11 b/g protocols including secure WEP and WPA protocols to allow wireless connection to the router. It will be appreciated that other wireless protocols, such as 802.11N and others as known in the art, can also be used with the WAP interface.

The router 60 can also function as a DHCP host. As a DHCP host, the router can issue IP configuration service to the server 40 and other devices attached via the LAN interface 62 or WAP interface 64 via the communications hub 80.

Thus, the router 60 can provide internet access to the server 40 and to computers 88 and 90 networked to the communications hub 80. Additionally, the microprocessor 61 of the router can include authentication access control programming to enable or restrict access to the server to authorized or un-authorized users, respectively, to further control internet access, and to allow for use as a WiFi hotspot for internet access services. The authentication access control program can allow the router to provide access control to restrict unauthorized access to the video surveillance system 10. Additionally, the router can be programmable to provide port forwarding and dynamic DNS service to allow incoming internet traffic access to the server.

As mentioned above, the router 60 can include a WiFi mobile hotspot authentication protocol to provide internet distribution of video data from the video surveillance system 10 to authorized users. The microprocessor 61 of the router can be programmed to interface with 3G and 4G Mobile Broadband Internet USB modem types 68 and is online firmware upgradeable to add additional modem types. Use of an active Mobile Broadband USB modem 68 in communication with the router via a USB modem/WAN interface 66 can provide Internet access to clients connected to the LAN including the server 40 and wireless clients connected via the Wireless Access Point (WAP), indicated generally at 94.

Additionally, the microprocessor 61 of the router 60 can include programming to provide access to custom programmed web pages stored in the router that are displayed on a web browser when clients attempt to connect to the router through the WAP 94. These custom web pages can be used to instruct the client on the proper usage of the video surveillance system 10 with respect to setting up the camera, linking the camera and the video data management device 30 to the Internet, and setting the router up as a Wi-Fi hotspot interface.

The communication hub 80 can receive and deliver video data from the video camera 20 to the server 40 and the router 60. The communication hub can include a physical switch 96 for switching between the LAN, indicated generally at 86, and the WAP, indicated generally at 94. The communication hub is one means for networking the internet protocol video server, the mobile broadband router, and the data storage device 100.

In one aspect, the communication hub can provide communication to the server 40 through an Ethernet LAN interface 84 wired to an Ethernet Switch 82. As shown in FIG. 4, the switch 96 can be positioned in the LAN position to connect the server 40 to the external Ethernet connector, to the LAN interface 62 of the router, or to an electronic Ethernet switch that allows for simultaneous communication on a router based LAN, indicated generally at 86 including personal computers 88 and laptop computers 90 coupled in a local IP network. With the switch positioned in the LAN position clients networked to the LAN can access the video data management device to retrieve data, view live acquired video feeds, and perform maintenance and programming functions for the video surveillance device 10.

In another aspect, the communications hub 80 can include a wireless transmitter 92. The wireless transmitter can create a wireless access point (WAP), indicated generally at 94, for transmitting a wireless signal from the video data management device 30 to a WiFi enabled computer.

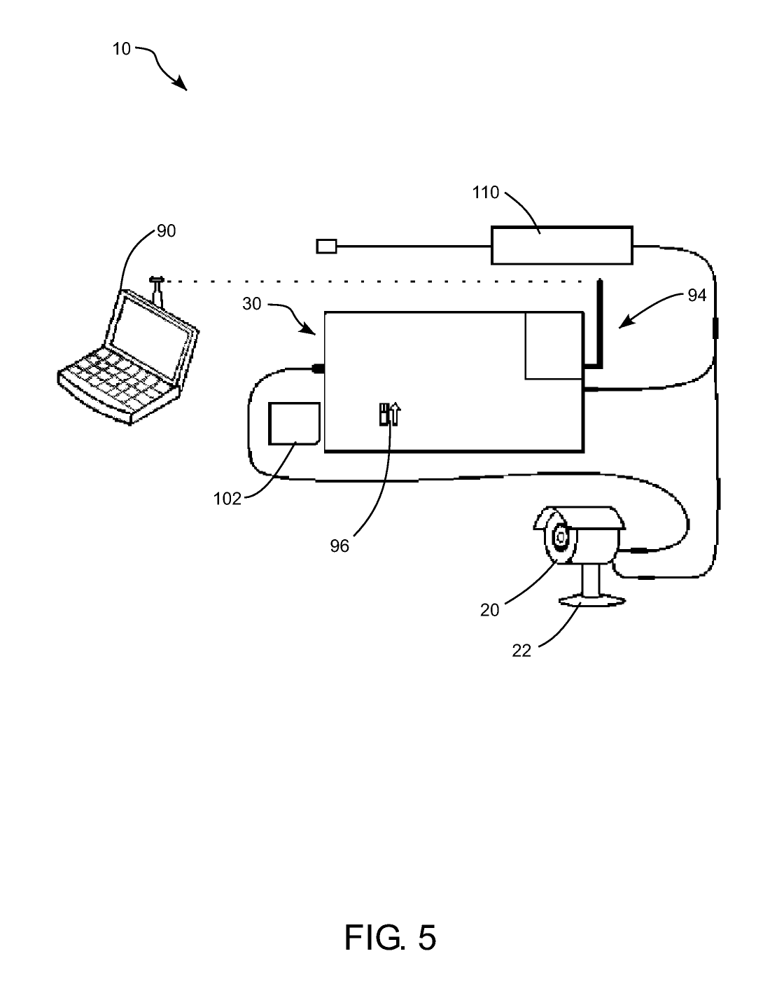

As shown in FIG. 5, the switch 96 can be positioned the wireless position to activate the WAP 94 so that wireless clients connected to the video data management device 30 by way of the WAP or Internet can access the server 40 and retrieve data, view live acquired video feeds, perform programming and maintenance functions from remote locations. Clients connected via the WAP 94 will have access to the server when located within the physical limits of the signal strength of the remote computer and the WAP. Clients connected via Internet through Mobile Broadband USB Modem connection 66 will have access when the signal strength for the USB modem 68 is sufficient to provide a stable Internet connection, and may be located anywhere they may find Internet access.

Hence, with an internet connection through the router 60, LAN 86, or WAP 94 the server 40 can support multiple simultaneous client access connections. For example, in one embodiment, there can be as many as 8 users connected to the server concurrently. This concurrent access is a particular advantage of the video surveillance system 10 described herein.

The data storage device 100 can be in communication with the video camera 20 through the server 40 and can record and store video data from the video camera. The data storage device can include a removable non-volatile computer memory device 102 such as ROM, PROM, EPROM, EEPROM, flash memory, microflash memory, FeRAM, MRAM, CBRAM, PRAM, SONOS, RRAM, NRAM, Racetrack memory, millipede memory, secure digital cards, mini SD, Micro SD, Compact flash, USB Stick memory, USB hard drives, and the like. It will be appreciated that other non-volatile computer memory devices, as known in the art, can also be used as the storage medium.

The server 40 can be the master controller for the data storage device 100. The data storage device may be formatted to allow files to be stored, viewed and archived using commonly available media player programs found on many available computer operating systems. Firmware and software upgrades to the server may be performed from files stored on the data storage device.

The video surveillance system 10 can also include power regulator circuits, indicated generally at 110, and a power supply 112 (FIGS. 1, 4-5). The video camera 20 and video data management device 30 together can have a relatively low power consumption of less than approximately 700 milliamps. In one aspect, the power consumption can be as low as approximately 650 milliamps.

In one embodiment, power can be provided by a 120 volt ac power source (not shown). In another embodiment, power for the surveillance system 10 can be provided by a 12 volt dc power source 112 (FIGS. 4-5) such as found in a motor vehicle, portable generator, or solar photovoltaic power cell. The IPVS 40 can be powered by the 12 volt dc power source, while the mobile broadband router 60 can be powered by 5 volts dc regulated by the power regulator circuit, indicated generally at 110 (FIG. 1). In one embodiment, the power supply can include a solar voltaic charging device (not shown) and at least one rechargeable battery (not shown).

Advantageously, the low power consumption and mobile broadband router features of the embodiments of the video surveillance device 10 described herein make the video surveillance system 10 suitable for a wide variety of remote and/or mobile uses. For example, the system can be used in school transportation busses, in playgrounds, and sports fields. Additionally, the system is ideal for law enforcement use in vehicles and in remote monitoring security situations such as jails. Fire departments and ambulances can also effectively deploy the system for recording and monitoring emergency situations. The system can also be used effectively in many commercial applications such as taxis, trucking companies, and public transportation.

As illustrated in FIG. 6, the present invention also provides for a method for remotely accessing a video surveillance camera through an internet connection, indicated generally at 300. The method can include placing a video camera in communication with an internet connectible video data management device, as shown at 310. Port forwarding settings in a mobile broadband router in the video data management device can be set to forward inbound internet traffic to an internet protocol video server in the video data management device, as shown at 320. Audio-visual data from the video camera can be acquired, compressed and transformed via the internet protocol video server, as shown at 330. A unique web name can be assigned to the video data management device via a Dynamic DNS service, as shown at 340. The audio-visual data acquired and compressed by the server in the video data management device can be accessed via the unique web name from an internet enabled computer, as shown at 350.

The step of assigning a unique web name to the video data management device can also include obtaining a static IP address from an ISP and a registration of the IP address with a dynamic DNS service.

In one aspect, the method can also include setting a network selection switch on the video data management device to a wireless position. An internet connection can be established to a wireless access point of the mobile broadband router in the video data management device connected to the video surveillance camera.

In another aspect, the method can include setting a network selection switch on the video data management device to a LAN Position. The video data management device can be connected to a LAN connected computer. An internet protocol address assigned to the internet protocol video server can be determined, and the internet protocol video server can be accessed using the IP address via the mobile broadband router with the LAN connected computer.

Additionally, a user can access the video through the unique website name in a variety of formats including a live video stream, stored video data, still images, a single camera, and a plurality of cameras, and the like.

The present invention also provides for a method for alerting a user to activity at a video surveillance camera including placing a video camera in communication with an internet connectible video data management device. A motion detection device can be in communication with the video surveillance camera to activate the camera in the presence of motion near the detector. Audio-visual data from the video camera can be acquired and compressed via an internet protocol video server. The server can deliver an electronic alarm notification by way of an email message, SMS text, FTP, an instant message, a microblog message, a text message, a telephonic voice message, and the like to alert the user the video camera has been active. Programming in the server can transform the data from the motion detector and the video camera so that the alarm notification can include text, audio, pictorial and video clip data from the video camera.

The embodiments of the present invention described herein provide several advantages for the video surveillance system 10. For example, the video surveillance system of the present invention uses non-volatile memory that has a much wider operating temperature range and is not susceptible to many conditions such as shock, magnetism, cold, heat, humidity, media deterioration, and other environmental factors that can damage a hard drive.

Additionally, the system of the present invention allows for removal of the non-volatile memory, wireless LAN download and internet download of video data. Most other systems require additional communications hardware to accomplish what is built in to the video surveillance systems described herein. This reduces the need for removal of the storage memory from the recording unit followed by installation into a playback unit.

The present invention also has an integrated hardwired LAN, wireless 802.11G, and optional wireless broadband capability through the use of USB broadband cards from any cell phone provider. Other video surveillance systems allow for only one communication option and require additional hardware to add more.

The communications options available on the embodiments of the video surveillance system described herein provide video that can be viewed and downloaded from a remote location through the use of internet browser software. Additionally, the present system has options for TCP/IP, DHCP, HTTP, SMTP, DDNS, FTP, SNTP, PpOE, and auto-sensing MDIX. Other systems only allow for basic network compatibility.

The present video surveillance system also can alert the user to programmable alarm events remotely through Email, SMS text, Text plus picture, FTP download, and the like. Furthermore, all of the hardware of the present invention uses less than approximately 700 milliamps. Typical hard drive systems use between 5 and 15 amps for basic service and optional add on accessories such as a mobile broadband router would require more power. All of these advantages allow the embodiments of the video surveillance system described herein to operate more efficiently and have lower cost than existing systems.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed:

1. A video surveillance system, comprising:
a) a video camera; and
b) a video data management device in communication with the video camera to receive video data from the video camera, the video data management device further comprising:
i) an internet protocol video server for acquiring and encoding at least one audio-visual data stream into an optimal format for storage and transmission of the video data;
ii) a mobile broadband router providing internet access to stored video data and live video feed from the video camera;
iii) a communications hub for receiving and delivering video data from the video camera; and
iv) a data storage device in communication with the video camera for recording and storing video data from the video camera.

2. The system of claim 1, wherein the internet protocol video server receives and transmits audio-visual data stream signals selected from the group consisting of digital video, analog video, digital audio, analog audio, and combinations thereof.

3. The system of claim 1, wherein the internet protocol video server encodes the audio-visual data stream into a format selected from the group consisting of MJPEG, MPEG4, AVI, H263, 3GPP, 3GPP2, .60d CCTV, .AJP CCTV, ASF, ASX, AVC Blueray, FLV, GVI, iMOVIE, ISF, M4V, MOV, VOB, DVD, WMV, and combinations thereof.

4. The system of claim 1, wherein the server further includes:
programmable alarm event triggers programmed to serve notice of predetermined alarm events in a form selected from the group consisting of an email message, SMS text, FTP, an instant message, a microblog message, a text message, a telephonic voice message, and combinations thereof.

5. The system of claim 1, wherein the server further includes a user interface selected from the group consisting of:
a) a user programmable interface that allows the user to program video data management features selected from the group consisting of video frame rate, resolution, image quality, recording schedule, and combinations thereof;
b) an authentication secured web-based interface that facilitates programming of server features;
c) an FTP upload interface to upload image files to a user defined FTP site;
d) a programmable GPIO interface with high or low level threshold inputs and high or low level output drives for interfacing with optional external monitoring devices; and
e) combinations thereof.

6. The system of claim 1, wherein the server further includes programming selected from the group consisting of:
a) programming to select an IP configuration state selected from the group consisting of a static IP configuration, an IP configuration received from an available DHCP host, and combinations thereof;
b) programming to provide video and audio output signals receivable by external video display and speaker devices;
c) programming to allow remote accessibility by an internet enabled computer to provide remote monitoring and programming of the video cameras;
d) programming to be a master controller for the media storage device; and
e) combinations thereof.

7. The system of claim 1, wherein the router includes connectivity features selected from the group consisting of:
a) a WAP interface with 802.11 b/g protocols including secure WEP and WPA protocols to allow wireless connection to the router;
b) a USB broadband modem interface to provide connectivity to the internet protocol video server;
c) a WiFi mobile hotspot authentication protocol to provide internet connectivity for distribution of video data to authorized users;
d) a LAN network to provide internet access to computers networked to the communications hub; and
e) combinations thereof.

8. The system of claim 1, wherein the router is a DHCP host and issues IP configuration service to the internet protocol video server and the communications hub.

9. The system of claim 1, wherein the router includes programming selected from the group consisting of:
a) programming for port forwarding and dynamic DNS service to allow incoming internet traffic access to the server;
b) programming for access control to restrict unauthorized access to the video surveillance system; and
c) combinations thereof.

10. The system of claim 1, wherein the communications hub includes an Ethernet switch that connects the router to the server and provides a LAN connection for connecting the video data management device to a local network with at least one personal computer.

11. The system of claim 1, wherein the communications hub includes a wireless transmitter defining a wireless access point for transmitting a wireless signal from the video data management device to a WiFi enabled computer.

12. The system of claim 1, wherein the data storage device is a non-volatile computer memory device selected from the group consisting of ROM, PROM, EPROM, EEPROM, flash memory, microflash memory, FeRAM, MRAM, CBRAM, PRAM, SONOS, RRAM, NRAM, Racetrack memory, millipede memory, secure digital cards, mini SD, Micro SD, Compact flash, USB Stick memory, USB hard drives, and combinations thereof.

13. The system of claim 1, wherein the video camera and video data management device together have a power consumption of less than approximately 700 milliamps, and as low as approximately 650 milliamps.

14. A method for remotely accessing a video surveillance camera through an internet connection, comprising:
a) placing a video camera in communication with an internet connectible video data management device;
b) setting port forwarding settings in a mobile broadband router in the video data management device to forward inbound internet traffic to an internet protocol video server in the video data management device;
c) acquiring and compressing audio-visual data from the video camera via the internet protocol video server;
d) assigning a unique web name to the video data management device via a Dynamic DNS service; and
e) accessing the audio-visual data acquired and compressed by the server in the video data management device via the unique web name on an internet enabled computer.

15. The method of claim 14, wherein the audio-visual data accessed via the unique web name is selected from the group consisting of a live audio-visual stream, stored audio-visual data, a live video stream, stored video data, a live audio stream, stored audio data, and combinations thereof.

16. The method of claim 14, wherein the step of assigning a unique web name to the video data management device includes obtaining a static IP address from an ISP and a registration of the IP address with a dynamic DNS service.

17. The method of claim 14, further comprising:
a) setting a network selection switch on the video data management device to a wireless position; and
a) establishing an internet connection to a wireless access point of the mobile broadband router in the video data management device connected to the video surveillance camera.

18. The method of claim 14, further comprising:
a) connecting the video data management device to a LAN connected computer;
a) determining an internet protocol address assigned to the internet protocol video server; and
b) accessing the internet protocol video server using the IP address via the mobile broadband router with the LAN connected computer.

19. A video surveillance system, comprising:
a) means for capturing video images;
b) means for acquiring and compressing the video images;
c) means for routing the video images to a remote computer; and
d) means for networking the means for acquiring and compressing and the means for routing to a network selected from the group consisting of a LAN, a wireless network, a WiFi network, a secured internet based network, an open internet based network, and combinations thereof.

20. The system of claim 19, wherein the means for capturing video, means for acquiring and compressing the video, means for routing the video, and means for networking together form an integrated, stand-alone, self-contained video data management device having a power consumption of less than approximately 700 milliamps, as low as approximately 650 milliamps.
